(19) United States
(12) Patent Application Publication
(10) Pub. No.: US 2005/0133614 A1
(43) Pub. Date: Jun. 23, 2005

(54) Spray pattern guide structure of a sprinkler

(75) Inventor: Chin-Yuan Chen, Chang-Hua Hsien (TW)

Correspondence Address: CHARLES E. BAXLEY, ESQ., 90 JOHN STREET, THIRD FLOOR, NEW YORK, NY, 10038, US

(73) Assignee: Shin Tai Spurt Water of the Garden Tools Co., Ltd., Chang-Hua Hsien (TW)

(21) Appl. No.: 10/741,962

(22) Filed: Dec. 22, 2003

(51) Int. Cl. B67D 5/08

(52) U.S. Cl. 239/71; 239/73; 239/526

(57) ABSTRACT

A sprinkler has a spray head which comprises an indicator and a spray pattern dial. The spray pattern dial is provided with a plurality of jet nozzles capable of spraying a liquid in various patterns, and a pattern scale contiguous to the indicator. The pattern scale is formed of a plurality of symbols representing spray patterns of the jet nozzles and corresponding in location to the jet nozzles.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a sprinkler, and more particularly to a spray pattern guide structure of the sprinkler.

### BACKGROUND OF THE INVENTION

As shown in FIG. 3, a spray head of the prior art comprises a spray-pattern dial 40 and a spray pattern scale 41 which is formed of a series of pattern marks expressed by English words. The spray pattern scale 41 is of course useful in an English-speaking country. In another words, the spray pattern scale 41 cannot be understood universally.

### BRIEF SUMMARY OF THE INVENTION

The primary objective of the present invention is to provide a spray head with a series of symbols representing the spray patterns. The symbols are corresponding in location to a series of jet nozzles of the spray head and are universally understood.

The features and the advantages of the present invention will be more readily understood upon a thoughtful deliberation of the following detailed description of the present invention with reference to the accompanying drawings.

### BRIEF DESCRIPTION OF THE SEVERAL VIEWS OF THE DRAWINGS

FIG. 1 shows a perspective view of a spray head of the present invention.

FIG. 2 shows a top plan view of the spray head of the present invention.

FIG. 3 shows a top plan view of a spray head of the prior art.

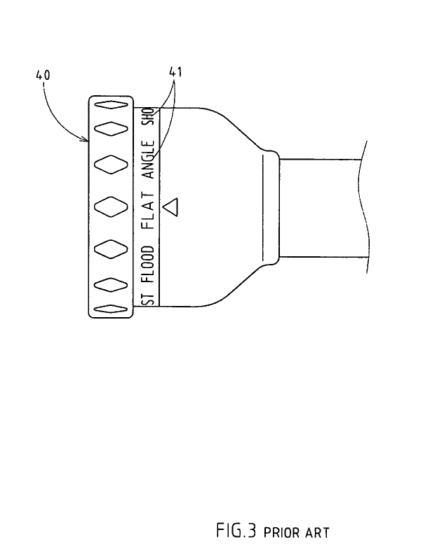

### DETAILED DESCRIPTION OF THE INVENTION

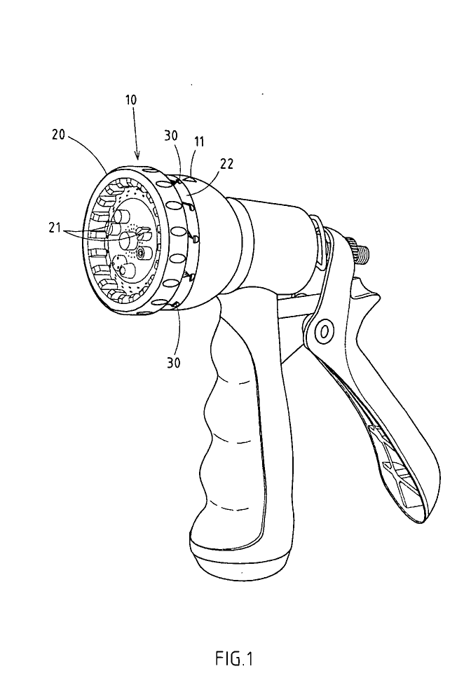

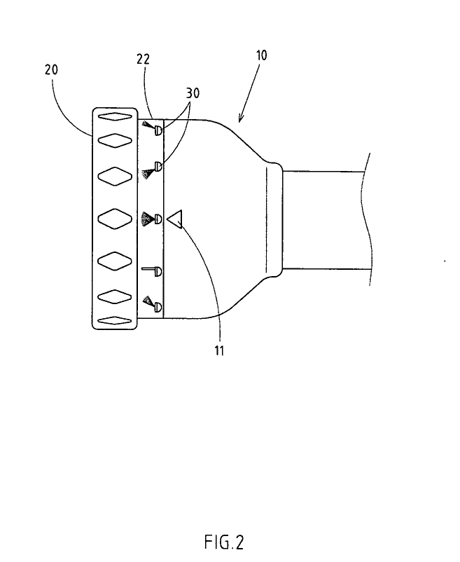

As shown in FIGS. 1 and 2, a spray head 10 embodied in the present invention comprises a spray pattern dial 20, a series of spray pattern symbols 30, and an indicator 11.

The spray pattern dial 20 is provided with a plurality of jet nozzles 21 capable of spraying water in various patterns, which are represented by the symbols 30. In another words, the symbols 30 are corresponding in location to the jet nozzles 21.

In operation, the spray pattern dial 20 is so turned that a desired symbol 30 is aligned with the indicator 11, the water is sprayed by a specific jet nozzle 21.

The symbols 30 form a pattern scale 22 of the present invention. The symbols 30 may be printed or indented.

The embodiment of the present invention described above is to be regarded in all respects as being illustrative and nonrestrictive. Accordingly, the present invention may be embodied in other specific forms without deviating from the spirit thereof. The present invention is therefore to be limited only by the scopes of the following claims.

1. A spray head comprising:
an indicator located peripherally; and
a spray pattern dial comprised of a plurality of jet nozzles capable of spraying a liquid in various patterns, said spray pattern dial further comprised of a pattern scale contiguous to said indicator;
wherein said pattern scale is comprised of a plurality of symbols representing spray patterns of said jet nozzles and corresponding in location to said jet nozzles.

2. The spray head as defined in claim 1, wherein said symbols are printed.

3. The spray head as defined in claim 1, wherein said symbols are indented.
